(19) United States
(12) Patent Application Publication
(10) Pub. No.: US 2011/0003942 A1
(43) Pub. Date: Jan. 6, 2011

(54) PROCESS FOR PRODUCING MODIFIED OLEFIN POLYMER

(75) Inventors: Hitoshi Tsukui, Chiba (JP); Tsuyoshi Takei, Chiba (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: SUMITOMO CHEMICAL COMPANY, LIMITED, Chuo-ku, Tokyo (JP)

(21) Appl. No.: 12/919,251

(22) PCT Filed: Feb. 19, 2009
(86) PCT No.: PCT/JP2009/053478

§ 371 Date: Aug. 25, 2010

(30) Foreign Application Priority Data
Feb. 29, 2008 (JP) 2008-049511

(51) Int. Cl. C08F 8/00

(52) U.S. Cl. 525/387

(57) ABSTRACT

A process for producing a modified olefin polymer includes the steps of: (1) blending 100 parts by weight of an olefin polymer, 0.01 to 20 parts by weight of a polar group-carrying unsaturated compound, and 0.001 to 20 parts by weight of an organic peroxide, with one another, in a continuous extruder at a temperature T1 for a time S1, thereby forming a first blend; (2) blending the first blend in the continuous extruder at a temperature T2 for a time S2, thereby forming a second blend; and (3) blending the second blend in the continuous extruder at a temperature T3 for a time S3. T1, T2 and T3 have specific relationships to decomposition temperatures of the organic peroxide, and S1, S2 and S3 have specific relationships to half-lives of the organic peroxide.

### TECHNICAL FIELD

The present invention relates to a process for producing a modified olefin polymer.

### BACKGROUND ART

A modified olefin polymer, which is obtained by grafting a polar group-carrying unsaturated compound such as maleic anhydride onto an olefin polymer such as polyethylene and polypropylene, is applied for use such as an adhesive agent and a compatiblilizing agents. As a process for producing a modified olefin polymer, there are known in the art a solution process conducting a graft reaction in a solution state, and a melting process conducting a graft reaction in a melting state.

Because a solution process needs a separating step and a recovering step of a large amount of solvents, it is a troublesome process, and also is not high in its economic efficiency. A melting process, which needs no solvent, particularly a melting process using an extruder can make a continuous production, and various sorts of melting processes have been proposed.

For example, JP 9-278956A discloses a process comprising the step of melt-kneading a propylene homopolymer, maleic anhydride and a specified organic peroxide with one another in a biaxial extruder, thereby producing a maleic anhydride-modified olefin polymer excellent in its adhesiveness; JP 2002-308947A discloses a production process using a combination of specific two kinds of organic peroxide; and JP 2002-121234A discloses a production process comprising the steps of (1) melt-kneading a molten ethylene polymer containing a radical initiator in a specified state with molten maleic anhydride at 200 to 270° C., (2) degassing, and (3) keeping the ethylene polymer in an extruder, and then melt-extruding, wherein the keeping time is three times or more a decomposition time during which 99.9% of the radical initiator is decomposed at above temperature.

### DISCLOSURE OF INVENTION

However, modified olefin polymers produced by conventional melting processes are not satisfactory yet sufficiently in their adhesiveness.

An object of the present invention is to provide a process for producing a modified olefin polymer excellent in its adhesiveness by a melting process.

Namely, the present invention is a process for producing a modified olefin polymer, comprising the steps of:

(1) blending 100 parts by weight of an olefin polymer, 0.01 to 20 parts by weight of a polar group-carrying unsaturated compound, and 0.001 to 20 parts by weight of an organic peroxide, with one another, in a continuous extruder at a temperature of T1 for a time of S1, wherein T1 is equal to, or lower than a decomposition temperature of Th1 at which the organic peroxide has a half-life of 1 hour, and S1 is shorter than a half-life of Sh1 of the organic peroxide at T1, thereby forming a first blend;

(2) blending the first blend in the continuous extruder at a temperature of T2 for a time of S2, wherein T2 is equal to, or higher than a decomposition temperature of Th2 at which the organic peroxide has a half-life of 10 seconds, and S2 is equal to, or longer than three times a half-life of Sh2 of the organic peroxide at T2, thereby forming a second blend; and

(3) blending the second blend in the continuous extruder at a temperature of T3 for a time of S3, wherein T3 is equal to, or lower than a decomposition temperature of Th3 at which the organic peroxide has a half-life of 10 hours, and S3 is equal to, or longer than S2.

### BEST MODE FOR CARRYING OUT THE INVENTION

The olefin polymer used in the present invention is not particularly limited, and is preferably a polymer obtained by polymerizing an olefin in the presence of a polymerization catalyst such as a metallocene catalyst.

Examples of the olefin are a linear olefin such as ethylene, propylene, 1-butene, 1-pentene, 1-hexene, 1-heptene, 1-octene, 1-nonene and 1-decene; and a branched olefin such as 3-methyl-1-butene, 3-methyl-1-pentene, 4-methyl-1-pentene, 4-methyl-1-hexene and 5-methyl-1-hexene. Among them, preferred is ethylene or an α-olefin having 3 to 20 carbon atoms, more preferred is ethylene, propylene, 1-butene, 1-pentene, 1-hexene, 1-heptene or 1-octene, and particularly preferred is ethylene or propylene.

In polymerizing an olefin in the presence of a metallocene catalyst, the olefin may be combined with other monomer copolymerizable with the olefin. Examples of the other monomer are cyclopentene, cyclohexene, styrene, vinylcyclohexane, vinylcycloheptane, vinylcyclooctane, 5-vinyl-2-norbornene, and 1-vinyladamantane.

Examples of the olefin polymer used in the present invention are an ethylene homopolymer, a propylene homopolymer, an ethylene-propylene copolymer, an ethylene-1-butene copolymer, an ethylene-1-hexene copolymer, ethylene-1-octene copolymer, an ethylene-propylene-butene copolymer, a propylene-1-butene copolymer, an ethylene-styrene copolymer, an ethylene-vinylcyclohexane copolymer, an ethylene-propylene-styrene copolymer, and an ethylene-propylene-vinylcyclohexane copolymer.

From a viewpoint of improvement of adhesiveness of a modified olefin polymer, a melt flow rate of the olefin polymer is preferably 50 g/10 minutes or more, and more preferably 100 g/10 minutes or more, measured at 190° C. under a load of 21.18 N prescribed in JIS (Japanese Industrial Standards) K7210. Also, from a viewpoint of improvement of ease of production of a modified olefin polymer, a melt flow rate thereof is preferably 1,000 g/10 minutes or less, and more preferably 500 g/10 minutes or less.

The olefin polymer is preferably (1) a polymer having a melting point of 80° C. or lower observed with a differential scanning calorimeter, or (2) a polymer having no melting point observed therewith, and having a softening point or a glass transition temperature of 80° C. or lower.

A molecular weight distribution (Mw/Mn) of the olefin polymer is preferably 2.5 or less, and more preferably 2.2 or less, represented by a ratio of its weight-average molecular weight (Mw) to its number-average molecular weight (Mn).

The above-mentioned metallocene catalyst is preferably a catalyst formed by combining a catalyst component of a transition metal complex represented by following formula [I], [II] or [III] with a co-catalyst component of an aluminum compound and/or boron compound mentioned hereinafter:

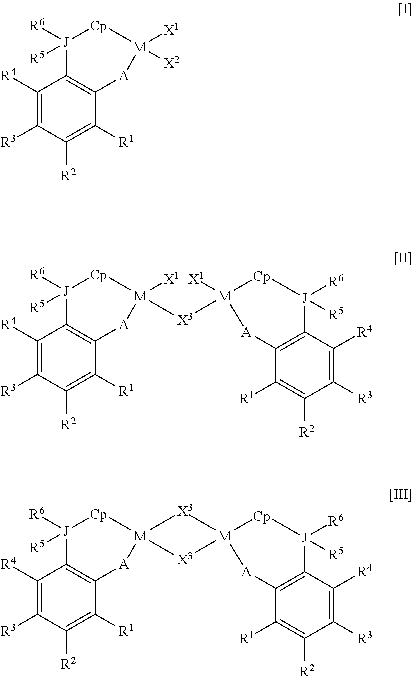

wherein M is a transition metal atom of group 4 in the periodic table of elements (revised IUPAC inorganic chemistry nomenclature, 1989); A is an atom of group 16 therein; J is an atom of group 14 therein; Cp is a cyclopentadiene-containing anionic group; R¹, R², R³, R⁴, X¹ and X² are independently of one another a hydrogen atom, a halogen atom, an alkyl group, an aralkyl group, an aryl group, a substituted silyl group, a di-substituted amino group, an alkoxy group, an aralkyloxy group, or an aryloxy group; hydrocarbyl groups of said alkyl, aralkyl, aryl and substituted silyl group, a hydrocarbyl group of said di-substituted amino group, and said alkoxy, aralkyloxy and aryloxy groups may be substituted by a halogen atom, an alkoxy group, an aryloxy group or an aralkyloxy group; any two of R¹, R², R³ and R⁴ may be bonded to each other to form a ring; R⁵ and R⁶ are independently of each other a methyl group or an ethyl group; X³ is an atom of group 16 in the periodic table of elements; and two Ms, two As, two Js, two Cps, two R¹s, two R²s, two R³s, two R⁴s, two X¹s and two X³s in formulas [II] and [III] are the same as, or different from each other, respectively.

Examples of the above-mentioned M are a titanium atom, a zirconium atom and a hafnium atom. Among them, preferred is a titanium atom or a zirconium atom.

Examples of the above-mentioned A are an oxygen atom, a sulfur atom and a selenium atom. Among them, preferred is an oxygen atom.

Examples of the above-mentioned J are a carbon atom, a silicon atom and a germanium atom. Among them, preferred is a carbon atom or a silicon atom.

Examples of the above-mentioned Cp are an η⁵-(substituted)cyclopentadienyl group, an η⁵-(substituted)indenyl group, and an η⁵-(substituted)fluorenyl group. Specific examples thereof are an η⁵-cyclopentadienyl group, an η⁵-methylcyclopentadienyl group, an η⁵-dimethylcyclopentadienyl group, an η⁵-trimethylcyclopentadienyl group, an η⁵-tetramethylcyclopentadienyl group, an η⁵-indenyl group, an η⁵-methylindenyl group, an η⁵-dimethylindenyl group, an η⁵-hydroxyindenyl group, an η⁵-dihydroindenyl group, an η⁵-trihydroindenyl group, an η⁵-tetrahydroindenyl group, an η⁵-fluorenyl group, an η⁵-methylfluorenyl group, and an η⁵-dimethylfluorenyl group. Among them, preferred is an η⁵-cyclopentadienyl group, an η⁵-tetramethylcyclopentadienyl group, an η⁵-indenyl group, or an η⁵-fluorenyl group.

Examples of the halogen atom of the above-mentioned R¹, R², R³, R⁴, X¹ and X² are a fluorine atom, a chlorine atom, a bromine atom and an iodine atom. Among them, preferred is a chlorine atom or a bromine atom, and more preferred is a chlorine atom.

The alkyl group of R¹, R², R³, R⁴, X¹ and X² is preferably an alkyl group having 1 to 20 carbon atoms. Examples of the alkyl group are a methyl group, an ethyl group, a n-propyl group, an isopropyl group, a n-butyl group, a sec-butyl group, a tert-butyl group, a n-pentyl group, a neopentyl group, a tert-pentyl group, a n-hexyl group, a n-octyl group, a n-decyl group, a n-dodecyl group, a n-pentadecyl group, and a n-eicodecyl group. Among them, preferred is a methyl group, an ethyl group, an isopropyl group, a tert-butyl group, or a tert-pentyl group.

A further example of the alkyl group of R¹, R², R³, R⁴, X¹ and X² is an alkyl group substituted by a halogen atom such as a fluorine atom, a chlorine atom, a bromine atom and an iodine atom. Examples of a C₁₋₂₀ alkyl group substituted by a halogen atom are a fluoromethyl group, a difluoromethyl group, a trifluoromethyl group, a chloromethyl group, a dichloromethyl group, a trichloromethyl group, a bromomethyl group, a dibromomethyl group, a tribromomethyl group, an iodomethyl group, a diiodomethyl group, a triiodomethyl group, a fluoroethyl group, a difluoroethyl group, a trifluoroethyl group, a tetrafluoroethyl group, a pentafluoroethyl group, a chloroethyl group, a dichloroethyl group, a trichloroethyl group, a tetrachloroethyl group, a pentachloroethyl group, a bromoethyl group, a dibromoethyl group, a tribromoethyl group, a tetrabromoethyl group, a pentabromoethyl group, a perfluoropropyl group, a perfluorobutyl group, a perfluoropentyl group, a perfluorohexyl group, a perfluorooctyl group, a perfluorododecyl group, a perfluoropentadecyl group, a perfluoroeicosyl group, a perchloropropyl group, a perchiorobutyl group, a perchloropentyl group, a perchlorohexyl group, a perchlorooctyl group, a perchiorododecyl group, a perchloropentadecyl group, a perchloroeicosyl group, a perbromopropyl group, a perbromobutyl group, a perbromopentyl group, a perbromohexyl group, a perbromooctyl group, a perbromododecyl group, a perbromopentadecyl group, and a perbromoeicosyl group.

A still further example of the alkyl group of R¹, R², R³, R⁴, X¹ and X² is an alkyl group substituted by an alkoxy group such as a methoxy group and an ethoxy group; an aryloxy group such as a phenoxy group; or an aralkyloxy group such as a benzyloxy group.

The aralkyl group of R¹, R², R³, R⁴, X¹ and X² is preferably an aralkyl group having 7 to 20 carbon atoms. Examples of the aralkyl group are a benzyl group, a (2-methylphenyl)methyl group, a (3-methylphenyl)methyl group, a (4-methylphenyl)methyl group, a (2,3-dimethylphenyl)methyl group, a (2,4-dimethylphenyl)methyl group, a (2,5-dimethylphenyl)methyl group, a (2,6-dimethylphenyl)methyl group, a (3,4-dimethylphenyl)methyl group, a (4,6-dimethylphenyl)methyl group, a (2,3,4-trimethylphenyl)methyl group, a (2,3,5-trimethylphenyl)methyl group, a (2,3,6-trimethylphenyl)methyl group, a (3,4,5-trimethylphenyl)methyl group, a (2,4,6-trimethylphenyl)methyl group, a (2,3,4,5-tetramethylphenyl)methyl group, a (2,3,4,6-tetramethylphenyl)methyl group, a (2,3,5,6-tetramethylphenyl)methyl group, a (pentamethylphenyl)methyl group, an (ethylphenyl)methyl group, a (n-propylphenyl)methyl group, an (isopropylphenyl)methyl group, a (n-butylphenyl)methyl group, a (sec-butylphenyl)methyl group, a (tert-butylphenyl)methyl group, a (n-pentylphenyl)methyl group, a (neopentylphenyl)methyl group, a (n-hexylphenyl)methyl group, a (n-octylphenyl)methyl group, a (n-decylphenyl)methyl group, a (n-decylphenyl)methyl group, a (n-tetradecylphenyl)methyl group, a naphthylmethyl group, and an anthracenylmethyl group. Among them, preferred is a benzyl group.

A further example of the aralkyl group of R¹, R², R³, R⁴, X¹ and X² is an aralkyl group substituted by a halogen atom such as a fluorine atom, a chlorine atom, a bromine atom and an iodine atom; an alkoxy group such as a methoxy group and an ethoxy group; an aryloxy group such as a phenoxy group; or an aralkyloxy group such as a benzyloxy group.

The aryl group of R¹, R², R³, R⁴, X¹ and X² is preferably an aryl group having 6 to 20 carbon atoms. Examples of the aryl group are a phenyl group, a 2-tolyl group, a 3-tolyl group, a 4-tolyl group, a 2,3-xylyl group, a 2,4-xylyl group, a 2,5-xylyl group, a 2,6-xylyl group, a 3,4-xylyl group, a 3,5-xylyl group, a 2,3,4-trimethylphenyl group, a 2,3,5-trimethylphenyl group, a 2,3,6-trimethylphenyl group, a 2,4,6-trimethylphenyl group, a 3,4,5-trimethylphenyl group, a 2,3,4,5-tetramethylphenyl group, a 2,3,4,6-tetramethylphenyl group, a 2,3,5,6-tetramethylphenyl group, a pentamethylphenyl group, an ethylphenyl group, a n-propylphenyl group, an isopropylphenyl group, a n-butylphenyl group, a sec-butylphenyl group, a tert-butylphenyl group, a n-pentylphenyl group, a neopentylphenyl group, a n-hexylphenyl group, a n-octylphenyl group, a n-decylphenyl group, a n-dodecylphenyl group, a n-tetradecylphenyl group, a naphthyl group and an anthracenyl group. Among them, preferred is a phenyl group.

A further example of the aryl group of R¹, R², R³, R⁴, X¹ and X² is an aryl group substituted by a halogen atom such as a fluorine atom, a chlorine atom, a bromine atom and an iodine atom; an alkoxy group such as a methoxy group and an ethoxy group; an aryloxy group such as a phenoxy group; or an aralkyloxy group such as a benzyloxy group.

The substituted silyl group of R¹, R², R³, R⁴, X¹ and X² means a silyl group substituted by a hydrocarbyl group. The hydrocarbyl group may be substituted by a halogen atom such as a fluorine atom, a chlorine atom, a bromine atom and an iodine atom; an alkoxy group such as a methoxy group and an ethoxy group; an aryloxy group such as a phenoxy group; or an aralkyloxy group such as a benzyloxy group. Examples of the hydrocarbyl group are a C₁₋₁₀ alkyl group such as a methyl group, an ethyl group, a n-propyl group, an isopropyl group, a n-butyl group, a sec-butyl group, a tert-butyl group, an isobutyl group, a n-pentyl group, a n-hexyl group, and a cyclohexyl group; and an aryl group such as a phenyl group.

The substituted silyl group is preferably a substituted silyl group having 1 to 20 carbon atoms. Examples of the substituted silyl group are a mono-substituted silyl group having 1 to 20 carbon atoms such as a methylsilyl group, an ethylsilyl group and a phenylsilyl group; a di-substituted silyl group having 2 to 20 carbon atoms such as a dimethylsilyl group, a diethylsilyl group and a diphenylsilyl group; and a tri-substituted silyl group having 3 to 20 carbon atoms such as a trimethylsilyl group, a triethylsilyl group, a tri-n-propylsilyl group, a triisopropylsilyl group, a tri-n-butylsilyl group, a tri-sec-butylsilyl group, a tri-tert-butylsilyl group, a triisobutylsilyl group, a tert-butyl-dimethylsilyl group, a tri-n-pentylsilyl group, a tri-n-hexylsilyl group, a tricyclohexylsilyl group, and a triphenylsilyl group. Among them, preferred is a trimethylsilyl group, a tert-butyl-dimethylsilyl group or a triphenylsilyl group.

The di-substituted amino group of R¹, R², R³, R⁴, X¹, and X² means an amino group substituted by two hydrocarbyl groups. The hydrocarbyl group may be substituted by a halogen atom such as a fluorine atom, a chlorine atom, a bromine atom and an iodine atom; an alkoxy group such as a methoxy group and an ethoxy group; an aryloxy group such as a phenoxy group; or an aralkyloxy group such as a benzyloxy group. Examples of the hydrocarbyl group are a C₁₋₁₀ alkyl group such as a methyl group, an ethyl group, a n-propyl group, an isopropyl group, a n-butyl group, a sec-butyl group, a tert-butyl group, an isobutyl group, a n-pentyl group, a n-hexyl group, and a cyclohexyl group; and a C₇₋₁₀ aralkyl group.

The di-substituted amino group is preferably a di-substituted amino group substituted by a C₁₋₁₀ hydrocarbyl group. Examples of the di-substituted amino are a dimethylamino group, a diethylamino group, a di-n-propylamino group, a diisopropylamino group, a di-n-butylamino group, a di-sec-butylamino group, a di-tert-butylamino group, a diisobutylamino group, a tert-butylisopropylamino group, a di-n-hexylamino group, a di-n-octylamino group, a di-n-decylamino group, a diphenylamino group, a bistrimethylsilylamino group, and a bis-tert-butyldimethylsilylamino group. Among them, preferred is a dimethylamino group or a diethylamino group.

The alkoxy group of R¹, R², R³, R⁴, X¹ and X² is preferably an alkoxy group having 1 to 20 carbon atoms. Examples of the alkoxy group are a methoxy group, an ethoxy group, a n-propoxy group, an isopropoxy group, a n-butoxy group, a sec-butoxy group, a tert-butoxy group, a n-pentoxy group, a neopentoxy group, a n-hexoxy group, a n-octoxy group, a n-dodecoxy group, a n-pentadecoxy group, and a n-eicosoxy group. Among them, preferred is a methoxy group, an ethoxy group or a tert-butoxy group.

A further example of the alkoxy group of R¹, R², R³, R⁴, X¹ and X² is an alkoxy group substituted by a halogen atom such as a fluorine atom, a chlorine atom, a bromine atom and an iodine atom; an alkoxy group such as a methoxy group and an ethoxy group; an aryloxy group such as a phenoxy group; or an aralkyloxy group such as a benzyloxy group.

The aralkyloxy group of R¹, R², R³, R⁴, X¹ and X² is preferably an aralkyloxy group having 7 to 20 carbon atoms. Examples of the aralkyloxy group are a benzyloxy group, a (2-methylphenyl)methoxy group, a (3-methylphenyl)methoxy group, a (4-methylphenyl)methoxy group, a (2,3-dimethylphenyl)methoxy group, a (2,4-dimethylphenyl)methoxy group, a (2,5-dimethylphenyl)methoxy group, a (2,6-dimethylphenyl)methoxy group, a (3,4-dimethylphenyl)methoxy group, a (3,5-dimethylphenyl)methoxy group, a (2,3,4-trimethylphenyl)methoxy group, a (2,3,5-trimethylphenyl)methoxy group, a (2,3,6-trimethylphenyl)methoxy group, a (2,4,5-trimethylphenyl)methoxy group, a (2,4,6-trimethylphenyl)methoxy group, a (3,4,5-trimethylphenyl)methoxy group, a (3,4,5-trimethylphenyl)methoxy group, a (2,3,4,5-tetramethylphenyl)methoxy group, a (2,3,4,6-tetramethylphenyl)methoxy group, a (2,3,5,6-tetramethylphenyl)methoxy group, a (pentamethylphenyl)methoxy group, an (ethylphenyl)methoxy group, a (n-propylphenyl)methoxy group, an (isopropylphenyl)methoxy group, a (n-butylphenyl)methoxy group, a (sec-butylphenyl)methoxy group, a (tert-butylphenyl)methoxy group, a (n-hexylphenyl)methoxy group, a (n-octylphenyl)methoxy group, a (n-decylphenyl)methoxy group, a (n-tetradecylphenyl)methoxy group, a naphthylmethoxy group and an anthracenylmethoxy group. Among them, preferred is a benzyloxy group.

A further example of the aralkyloxy group of R¹, R², R³, R⁴, X¹ and X² is an aralkyloxy group substituted by a halogen atom such as a fluorine atom, a chlorine atom, a bromine atom and an iodine atom; an alkoxy group such as a methoxy group and an ethoxy group; an aryloxy group such as a phenoxy group; or an aralkyloxy group such as a benzyloxy group.

The aryloxy group of R¹, R², R³, R⁴, X¹ and X² is preferably an aryloxy group having 6 to 20 carbon atoms. Examples of the aryloxy group are a phenoxy group, a 2-methylphenoxy group, a 3-methylphenoxy group, a 4-methylphenoxy group, a 2,3-dimethylphenoxy group, a 2,4-dimethylphenoxy group, a 2,5-dimethylphenoxy group, a 2,6-dimethylphenoxy group, a 3,4-dimethylphenoxy group, a 3,5-dimethylphenoxy group, a 2,3,4-trimethylphenoxy group, a 2,3,5-trimethylphenoxy group, a 2,3,6-trimethylphenoxy group, a 2,4,5-trimethylphenoxy group, a 2,4,6-trimethylphenoxy group, a 3,4,5-trimethylphenoxy group, a 2,3,4,5-tetramethylphenoxy group, a 2,3,4,6-tetramethylphenoxy group, a 2,3,5,6-tetramethylphenoxy group, a pentamethylphenoxy group, an ethylphenoxy group, a n-propylphenoxy group, an isopropylphenoxy group, a n-butylphenoxy group, a sec-butylphenoxy group, a tert-butylphenoxy group, a n-hexylphenoxy group, a n-octylphenoxy group, a n-decylphenoxy group, a n-tetradecylphenoxy group, a naphthoxy group and an anthracenoxy group.

A further example of the aryloxy group of R¹, R², R³, R⁴, X¹ and X² is an aryloxy group substituted by a halogen atom such as a fluorine atom, a chlorine atom, a bromine atom and an iodine atom; an alkoxy group such as a methoxy group and an ethoxy group; an aryloxy group such as a phenoxy group; or an aralkyloxy group such as a benzyloxy group.

R¹, R², R³ and R⁴ are preferably an alkyl group, an aralkyl group, an aryl group, or a substituted silyl group.

X¹, and X² are preferably a halogen atom, an alkyl group, an aralkyl group, an alkoxy group, an aryloxy group, or a di-substituted amino group, and further preferably a halogen atom or an alkoxy group.

Examples of X³ are an oxygen atom, a sulfur atom and a selenium atom. Among them, preferred is an oxygen atom.

The transition metal complex represented by formula [I] can be produced by a method disclosed in a literature known in the art such as WO97/03992.

The transition metal complex represented by formula [II] can be produced by a reaction of one part by mole of the transition metal complex represented by formula [I] with 0.5 part by mole of water.

The transition metal complex represented by formula [III] can be produced by a reaction of one part by mole of the transition metal complex represented by formula [I] with one part by mole of water.

Examples of a method for the above reaction of the transition metal complex represented by formula [I] with water are (1) a method of reacting the transition metal complex directly with a necessary amount of water, (2) a method of putting the transition metal complex in a solvent (for example, hydrocarbon solvent) containing a necessary amount of water, and (3) a method of putting the transition metal complex in a dry solvent (for example, hydrocarbon solvent), and then flowing thereto an inert gas containing a necessary amount of water.

Examples of the aluminum compound as the above co-catalyst component are following aluminum compounds (1), (2) and (3), and a combination thereof:

(1) an organoaluminum compound represented by a formula, E¹ₐAlZ₃₋ₐ;

(2) a cyclic alumoxane represented by a formula, {—Al(E²)—O—}_{b}; and

(3) a linear alumoxane represented by a formula, E³{—Al(E³)—O—}_{c}AlE³₂;

wherein a is a number satisfying 0<a≦3; b is an integer of 2 or more; c is an integer of 1 or more; E¹, E² and E³ are a hydrocarbyl group, which may be substituted with a halogen atom, and plural E¹s, E²s or E³s are the same as, or different from one another, respectively; and Z is a hydrogen atom or a halogen atom, and plural Zs are the same as, or different from one another.

Examples of the boron compound as the above co-catalyst component are following boron compounds (1), (2) and (3), and a combination thereof:

(1) a boron compound represented by a formula, BQ¹Q²Q³;

(2) a boron compound represented by a formula, G⁺(BQ¹Q²Q³Q⁴)⁻; and

(3) a boron compound represented by a formula, (L-H)⁺(BQ¹Q²Q³Q⁴)⁻;

wherein B is a trivalent boron atom; Q¹, Q², Q³ and Q⁴ are independently of one another a halogen atom, a hydrocarbyl group, a substituted silyl group, an alkoxy group, or a di-substituted amino group, and the hydrocarbyl group may be substituted with a halogen atom; G⁺ is an inorganic or organic cation; L is a neutral Lewis base; and (L-H)⁺ is a Broensted acid.

A metallocene catalyst can be prepared by contacting the above catalyst component with the above co-catalyst component in a hydrocarbon solvent or in a gas.

The aluminum compound is used in an amount of generally 0.1 to 10,000 mol, and preferably 5 to 2,000 mol, in terms of a molar amount of aluminum atoms contained in the aluminum compound, per one mol of a transition metal complex. The boron compound is used in an amount of generally 0.01 to 100 mol, and preferably 0.5 to 10 mol, per one mol of a transition metal complex.

When using a catalyst component and a co-catalyst component in their solution state or suspension state, a concentration of the solution or suspension is suitably selected based on a condition such as a performance of an apparatus through which the solution or suspension is supplied to a polymerization reactor. A concentration of the catalyst component is generally 0.01 to 500μ mol/g, preferably 0.05 to 100μ mol/g, and more preferably 0.05 to 50μ mol/g, per one gram of the solution or suspension. A concentration of the aluminum compound is generally 0.01 to 10,000μ mol/g, preferably 0.1 to 5,000μ mol/g, and more preferably 0.1 to 2,000μ mol/g, in terms of a molar amount of aluminum atoms contained in the aluminum compound, per one gram of the solution or suspension. A concentration of the boron compound is generally 0.01 to 500μ mol/g, preferably 0.5 to 200μ mol/g, and more preferably 0.5 to 100μ mol/g, per one gram of the solution or suspension.

A metallocene catalyst may be used in combination with a particulate support comprising an inorganic support such as SiO₂ and Al₂O₃, or an organic polymer support such as a polyethylene and polystyrene.

An olefin polymerization method is not particularly limited. Examples thereof are a batch-wise or continuous gas-phase polymerization method, bulk polymerization method, solution polymerization method, and slurry polymerization method. A solvent which does not deactivate a polymerization catalyst may be used as a polymerization solvent. Examples of the solvent are a hydrocarbon such as benzene, toluene, pentane, hexane, heptane, and cyclohexane; and a halogenated hydrocarbon such as dichlomethane and dichlorostyrene.

An olefin polymerization temperature is not particularly limited, and is generally −100 to 250° C., and preferably −50 to 200° C. A polymerization pressure is not also particularly limited, and is generally 10 MPa or lower, and preferably 0.2 to 5 MPa. In order to regulate a molecular weight of an olefin polymer produced, there may be used a chain transfer agent such as hydrogen.

Examples of the polar group contained in the polar group-carrying unsaturated compound used in the present invention are a hydroxyl group (—OH), an epoxy group (—O—), a carboxyl group (—COOH), an ester group (—COO—), a carbonyl group (—CO—), an amino group (—NH₂), an ammonium salt structure-carrying group derived from an amino group (—NH₃⁺, —RNH₂⁺, —R₂NH⁺ and —R₃N⁺, wherein R is an alkyl group), an imino group (—NH—), an amido group (—CONH₂), an isocyanate group (—NCO—), and a nitrile group (—NO₂). Examples of the unsaturated bond contained in the polar group-carrying unsaturated compound are a carbon-to-carbon double bond and a carbon-to-carbon triple bond.

Examples of the polar group-carrying unsaturated compound are an unsaturated carboxylic acid such as maleic acid and fumalic acid; an unsaturated carboxylic acid anhydride such as maleic anhydride; an unsaturated carboxylic acid ester such as methyl acrylate, ethyl acrylate and propyl acrylate; and an unsaturated carboxylic acid amide such as acrylic amide, methacrylic amide and 2-acetylacrylamide.

The polar group-carrying unsaturated compound is preferably an unsaturated carboxylic acid or an unsaturated carboxylic acid anhydride, and more preferably maleic acid or maleic anhydride.

Examples of the organic peroxide used in the present invention are ketone peroxides; diacyl peroxides such as di-o-methylbenzoyl peroxide and di-p-methylbenzyl peroxide; dialkyl peroxides such as dicumyl peroxide, 2,5-dimethyl-2,5-di(tert-butylperoxy)hexane, 1,3-bis(tert-butylperoxyisopropyl)benzene, tert-butylcumyl peroxide, di-tert-butyl peroxide, and 2,5-dimethyl-2,5-di(tert-butylperoxy)hexyne-3; peroxyketals such as 4,4-di-tert-butylperoxy-n-butyl valerate and 1,1-bis(tert-butylperoxy)cyclohexane; alkyl peresters; percarbonates; and hydroperoxides.

The organic peroxide is preferably diacyl peroxides, dialkyl peroxides, peroxyketals, alkyl peresters or percarbonates, and more preferably diacyl peroxides, dialkyl peroxides, alkyl peresters or percarbonates,

A decomposition temperature of the organic peroxide, at which the organic peroxide has a half-life of 1 minute, is preferably 90 to 210° C., from a viewpoint of improving adhesiveness of a modified olefin polymer. The “half-life” is a time wherein an amount of active oxygen contained in an organic peroxide has been reduced by half by its thermal decomposition. The half-life can be determined by dissolving an organic peroxide in a relatively inactive solvent such as benzene, thereby preparing a solution, then decomposing the solution thermally, thereby measuring a temporal change in a concentration of the organic peroxide contained in the solution, and calculating a half-life provided that a decomposition reaction at a given temperature is a first-order reaction, and a reaction constant and temperature of the decomposition reaction follow Arrhenius equation.

An amount of the polar group-carrying unsaturated compound in step (1) of the production process of the present invention is 0.01 to 20 parts by weight, and preferably 0.1 to 1 part by weight, per 100 parts by weight of the olefin polymer, from a viewpoint of improving adhesiveness of a modified olefin polymer.

An amount of the organic peroxide in the step (1) is 0.01 to 20 parts by weight, and preferably 0.002 to 1 part by weight, per 100 parts by weight of the olefin polymer, from a viewpoint of improving adhesiveness of a modified olefin polymer.

The organic peroxide in the step (1) may be dissolved in a solvent to prepare its solution state, which is supplied to a continuous extruder, or may be supported on a carrier such as calcium carbonate to prepare its supported state, which is supplied thereto.

Each of the olefin polymer, polar group-carrying unsaturated compound and organic peroxide in the step (1) may be combined with a vinyl aromatic compound such as styrene and divinyl benzene; or an additive known in the art such as an antioxidant, a heat stabilizer and a neutralizing agent.

The blending temperature (T1) in the step (1) is equal to, or lower than the decomposition temperature (Th1), at which the organic peroxide has a half-life of 1 hour. When the temperature (T1) is higher than the temperature (Th1), a modified olefin polymer may be decreased in its adhesiveness. The temperature (T1) is preferably 120° C. or lower, and more preferably 100° C. or lower, and generally 10° C. or higher, and preferably 30° C. or higher.

The blending time (S1) in the step (1) is shorter than the half-life (Sh1) of the organic peroxide at the blending temperature (T1). The time (S1) is preferably shorter than one hour, more preferably shorter than 30 minutes, and further preferably shorter than 10 minutes, and generally 0.01 second or longer, preferably 0.1 second or longer, and more preferably 1 second or longer.

The blending temperature (T2) in the step (2) is equal to, or higher than the decomposition temperature (Th2), at which the organic peroxide has a half-life of 10 seconds. When the temperature (T2) is lower than the temperature (Th2), a modified olefin polymer may be decreased in its adhesiveness. The temperature (T2) is preferably 150° 0 or higher, and more preferably 180° C. or higher, and generally 350° C. or lower, and preferably 280° C. or lower.

The blending time (S2) in the step (2) is equal to, or longer than three times the half-life (Sh2) of the organic peroxide at the blending temperature (T2). The time (S2) is preferably 0.001 second or longer, more preferably 0.01 second or longer, and further preferably 0.1 second or longer, and generally shorter than 10 times the time (Sh2), and preferably shorter than 10 minutes.

The blending temperature (T3) in the step (3) is equal to, or lower than the decomposition temperature (Th3), at which the organic peroxide has a half-life of 10 hours. When the temperature (T3) is higher than the temperature (Th3), a modified olefin polymer may be decreased in its adhesiveness. The temperature (T3) is preferably 120° C. or lower, and more preferably 100° C. or lower, and generally 10° C. or higher.

The blending time (S3) in the step (3) is equal to, or longer than the blending time (S2) in the step (2). When the time (S3) is shorter than the time (S2), a modified olefin polymer may be decreased in its adhesiveness. The time (S3) is preferably 1 second or longer, more preferably 10 seconds or longer, and further preferably 30 seconds or longer, and generally 60 minutes or shorter, and more preferably 10 minutes or shorter.

A continuous extruder used in the present invention is preferably a double screw extruder. Among them, preferred is a double screw extruder which has an L/D ratio of 30 to 100, and whose two screws rotate in the same direction, and engage partially or completely with each other.

Examples of the continuous extruder used in the present invention are (i) one continuous extruder containing three or more regions which are regulated in their temperatures corresponding to respective temperatures of the steps (1), (2) and (3) in order, and (ii) three continuous extruders which are regulated in their temperatures corresponding to respective temperatures of the steps (1), (2) and (3) in order, and are connected in series.

A modified olefin polymer in a molten state, which is extruded from a die nozzle of a continuous extruder in the step (3), generally goes through a cutting step with a cutter, and a solidifying step with cooling water, thereby shaping pellets. A method in the cutting and solidifying steps may be known in the art. Examples of the method are (i) an under water cutting method of cutting the modified olefin polymer in a molten state with a cutting blade to make pellets, and then solidifying the pellets with cooling water, and (ii) a cold cutting method of solidifying the modified olefin polymer in a molten state to form a strand, and then cutting the strand with a cutting blade to make pellets. The pellets generally have a spherical shape, an ellipsoidal spherical shape, or a cylindrical shape, which generally has a size of 1 to 20 mm in diameter and 1 to 20 mm in length.

### EXAMPLE

The present invention is explained according to the following Example.

### Reference Example 1

There were put 38.6 kg of vinylcyclohexane and 364 g of toluene in a SUS reactor substituted with dry nitrogen. The reactor was heated up to 50° C. in a sealed condition. Then, 0.015 MPa of hydrogen was introduced thereto. After completion of the introduction of hydrogen, 0.6 MPa of ethylene (partial pressure of ethylene) was introduced thereto. Next, 1.0 kg of a toluene solution (having a concentration of 20% by weight, manufactured by Tosoh Akzo Corporation) of triisobutylaluminum (co-catalyst component) was supplied thereto, and then, a solution of 0.1 g of diethylsilyl(tetramethylcyclopentadienyl)(3-tert-butyl-5-methyl-2-phenoxy)titanium dichloride (transition metal complex) in 8.7 kg of dehydrated toluene, and a solution of 3 g of dimethylanilinium tetrakis(pentafluorophenyl)borate (co-catalyst component) in 12.2 kg of dehydrated toluene were put therein, thereby initiating a polymerization. During the polymerization, the mixture in the reactor was agitated, and ethylene was supplied to the reactor so as to keep the partial pressure of ethylene at 0.6 MPa. Two hours after initiating the polymerization, 0.9 kg of ethanol was added to the resultant polymerization liquid. Then, hydrochloric acid having a concentration of 2% by weight was added thereto in the same amount as that of the polymerization liquid, thereby separating a water layer and an organic layer from each other. The organic layer was poured in a large amount of acetone, and a precipitated white solid was filtered off. The solid was washed with acetone, and was dried under a reduced pressure, thereby obtaining an olefin polymer (ethylene-vinylcyclohexane copolymer). The olefin polymer contained 88% by mol of ethylene units and 12% by mol of vinylcyclohexane units, the total of both units being 100% by mol, and had a melting point of 62° C., a melt flow rate of 140 g/10 minutes, and a molecular weight distribution (Mw/Mn) of 2.0.

The above ethylene unit content and vinylcyclohexane unit content were obtained by measuring a carbon nuclear magnetic resonance spectrum of the olefin polymer according to a carbon nuclear magnetic resonance method (¹³C-NMR), under the following measurement conditions, and calculating from the following formula:

### [Measurement Conditions]

apparatus: ARX 400 manufactured by Bruker;
measurement solvent; mixed solvent consisting of 4 parts by volume of o-dichlorobenzene and 1 part by volume of o-dichlorobenzene-d4;
measurement temperature: 408K;
measurement method: Powergate Decoupling method;
pulse angle: 45°; and
measurement standard: trimethylsilane.

### [Calculation Formula]

ethylene unit content (mol %)=100×(B−3A)/(B−2A); and

vinylcyclohexane unit content (mol %)=100×A/(B−2A);

wherein A is an integrated value of signals between 40 ppm and 45 ppm; and B is an integrated value of signals between 25 ppm and 35 ppm.

The above melting point (° C.) was measured according to the following steps (1) to (3), with a differential scanning calorimeter, SSC-5200, manufactured by Seiko Instruments & Electronics Ltd., using about 10 mg of the olefin polymer:

(1) heating from room temperature to 200° C. at a rate of 10° C./minute, and keeping at 200° C. for 10 minutes;

(2) cooling from 200° C. to −100° C. at a rate of 10° C./minute, and keeping at −100° C. for 10 minutes; and

(3) measuring a differential scanning calorimetry curve under heating from −100° C. to 200° C. at a rate of 10° C./minute, and considering a peak temperature of a highest endothermic peak as a melting point.

The above melt flow rate (g/10 minutes) was measured at 190° C. under a load of 21.18 N, according to a method prescribed in JIS K7210.

The above molecular weight distribution shown by a ratio (Mw/Mn) of a weight-average molecular weight (Mw) to a number-average molecular weight (Mn) was obtained by measuring a molecular weight distribution curve, with a gel permeation chromatograph manufactured by JASCO Corporation, under the following conditions:
column: TSK gel G6000+G5000+G4000+G3000HXL manufactured by Tosoh Corporation;
measurement temperature: 40° C.;
mobile phase: tetrahydrofuran;
sample concentration: 1 mg/ml; and
molecular weight standard material: standard polystyrenes.

### Example 1

There was used a continuous extruder, TEX 44, manufactured by The Japan Steel Works, Ltd. containing fifteen blocks for controlling a cylinder temperature, and having L/D of 52.5, and its inlet for supplying a starting material was adjusted at 40° or lower, and its screw rotation speed was adjusted at 320 rpm.

There were put 100 parts by weight of the olefin polymer obtained in Reference Example 1, 0.4 part by weight of maleic anhydride (polar group-carrying unsaturated compound), and 0.012 part by weight of 1,3-bis(tert-butylperoxyisopropyl)benzene (organic peroxide) in a polyethylene bag, in this order, which were pre-mixed by kneading with hands at 40° or lower.

The organic peroxide has a decomposition temperature of 140° C. (Th1) at which the organic peroxide has a half-life of one hour, has a decomposition temperature of 206° C. (Th2) at which the organic peroxide has a half-life of ten seconds, and has a decomposition temperature of 120° C. (Th3) at which the organic peroxide has a half-life of ten hours.

The above pre-mixture was supplied to the above extruder at a supply rate of 50 kg/hour, and was mixed in the upstream four blocks adjusted at 40° C. (T1) for a time (S1) shorter than one minute, thereby forming a first mixture (step (1)), then the first mixture was mixed in the middle-stream three blocks adjusted at 240° C. (T2) for about one minute (S2), thereby forming a second mixture (step (2)), and finally the second mixture was mixed in the downstream eight blocks adjusted at 40° C. (T3) for about one minute (S3), thereby obtaining a modified olefin polymer (step (3)).

A magnitude relation between the “mixing time of S1” and a “half-life of Sh1 at the mixing temperature of T1” is S1<Sh1, because a half-life at the decomposition temperature of Th1 is one hour, and the mixing temperature of T1<the decomposition temperature of Th1, and therefore the half-life of Sh1 at the mixing temperature of T1 is one hour or longer. Also, a magnitude relation between the “mixing time of S2” and a “half-life of Sh2 at the mixing temperature of T2” is Sh2×3<S2, because a half-life at the decomposition temperature of Th2 is ten seconds, and the mixing temperature of T2 >the decomposition temperature of Th2, and therefore the half-life of Sh2 at the mixing temperature of T2 is shorter than 10 seconds.

The modified olefin polymer contained 0.2% by weight of maleic acid units, the total of the modified olefin polymer being 100% by weight; had a melt flow rate of 180 g/10 minutes; and had a sealing strength to glass of 30 N/15 mm or more, and a sealing strength to polypropylene of 67 N/10 mm, which showed good adhesiveness.

The above maleic acid unit-content was measured by a method comprising the following steps:

(1) dissolving 1.0 g of the modified olefin polymer in 20 ml of xylene, thereby preparing a solution;

(2) adding the solution drop-wise to 300 ml of methanol under agitation, thereby re-precipitating the modified olefin polymer;

(3) recovering the re-precipitated modified olefin polymer;

(4) drying the recovered modified olefin polymer in vacuum at 80⁰C for 8 hours;

(5) hot-pressing the dried modified olefin polymer, thereby making a 100 μm-thick film;

(6) measuring an infrared spectrum of the film; and

(7) determining a maleic acid unit-content from an absorption in the vicinity of 1,780 cm⁻ of the spectrum.

The above sealing strength to glass was measured by a method comprising the steps of:

(1) coating one surface of a 12 μm-thick polyester film having a trade name of PTMX manufactured by Unitika Ltd. with a mixture of 10 parts by weight of an aliphatic ester coating agent (main agent) having a trade name of TAKELAC XA-525 manufactured by Mitsui Takeda Chemicals, Inc., 1 part by weight of a curing agent having a trade name of TAKENATE XA-52 manufactured by Mitsui Takeda Chemicals, Inc., and 15 parts by weight of ethyl acetate, by use of a coater manufactured by Yasui Seiki Co., Ltd.

(2) separately, corona-treating one surface of a 30 μm-thick film containing an polyethylene resin having a trade name of SUMIKATHENE L 405 manufactured by Sumitomo Chemical Co., Ltd.;

(3) pressure-bonding the coated surface of above (1) to the corona-treated surface of above (2), thereby preparing a two-layer film;

(4) heating the two-layer film at 40° C. in an oven for 24 hours;

(5) separately, compression-molding the modified olefin polymer obtained in Example 1 at 220° C. under a pressure of 100 kg/cm² with a compression molding machine manufactured by SHINTO Metal Industries Corporation, thereby preparing a 70 μm-thick film;

(6) laminating the 70 μm-thick film with the polyethylene resin layer of the above two-layer film;

(7) pressure-bonding the obtained laminate at 220° C. for one minute under a pressure of 100 kg/cm² with the above compression molding machine, thereby preparing a three-layer film;

(8) heat-sealing the modified olefin polymer layer of the three-layer film, in a 20 mm-wide band-like shape, on a square-shaped 2 mm-thick soda glass having 100 mm-length on one side manufactured by Hiraoka Special Glass Mfg. Co., Ltd., at 180° C. for one second under a pressure of 3 kg/cm²;

(9) cutting the heat-sealed laminate in a vertical direction to a heat-sealed surface, thereby preparing a 15 mm-wide test specimen; and

(10) measuring sealing strength between the soda glass and the three-layer film of the test specimen, at 23° C., at a tension rate of 300 mm/minute, with use of a tensile testing machine.

The above sealing strength to polypropylene was measured by a method comprising the steps of:

(1) preparing an upper adherend by a method comprising the steps of:

(1-1) making a 100 μm-thick sheet from polypropylene (NOBLENE AY 564) manufactured by Sumitomo Chemical Co., Ltd., with an extruder (LABO PLASTMIL) equipped with a 20 mm-diameter T die manufactured by TOYO SEIKI Co., Ltd.; and

(1-2) laminating one surface of the sheet with an aluminum foil, thereby preparing an upper adherend;

(2) making a 2 mm-thick sheet (lower adherend) from polypropylene (NOBLENE AY 564) manufactured by Sumitomo Chemical Co., Ltd., with a 5.5-ounce injection molding machine (IS 100 E) manufactured by Toshiba Corporation;

(3) pressing the modified olefin polymer obtained in Example 1 with a hot-press at 120° C. under a pressure of 5 MPa, thereby preparing an about 300 μm-thick sheet of the modified olefin polymer;

(4) laminating the modified olefin polymer sheet on the lower adherend, and further laminating thereon the polypropylene surface of the upper adherend;

(5) making the respective layers of the obtained laminate stick together with a rubber roll at a room temperature, wherein the laminate has a part which does not contain the modified olefin polymer sheet between the lower adherend and the upper adherend, so as to curve out a test specimen mentioned hereinafter;

(6) allowing the laminate to stand at 80° C. for 70 minutes under no pressure;

(7) further allowing the laminate to stand at 23° C. for 24 hours at 50% humidity, thereby obtaining the laminate;

(8) cutting the laminate in a vertical direction to the laminated surface, thereby preparing a test specimen having 10 mm-width and 100 mm-length, in which length a part of the laminate containing the lower adherend, the upper adherend and the modified olefin polymer sheet occupies 50 mm-length; and

(9) clutching each of the lower adherend and the upper adherend, and conducting a peel test at 23° C., 50% humidity, a peel rate of 200 mm/minute, and a peel angle of 180°, thereby measuring sealing strength.

### Comparative Example 1

Example 1 was repeated except that step (3) was omitted, namely, the step of mixing in the downstream eight blocks adjusted at 40° C. (T3) for about one minute (S3), thereby obtaining a modified olefin polymer.

The modified olefin polymer contained 0.2% by weight of maleic acid units, the total of the modified olefin polymer being 100% by weight; had a melt flow rate of 180 g/10 minutes; and had a sealing strength to polypropylene of 59 N/10 mm, which is an indicator of adhesiveness.

### INDUSTRIAL APPLICABILITY

A modified olefin polymer obtained by the production process of the present invention is excellent in its adhesiveness, and therefore, the modified olefin polymer is preferably used in a field such as an adhesive agent, a coating material and an adhesive compound (for example, primer).

1. A process for producing a modified olefin polymer, comprising the steps of:
(1) blending 100 parts by weight of an olefin polymer, 0.01 to 20 parts by weight of a polar group-carrying unsaturated compound, and 0.001 to 20 parts by weight of an organic peroxide, with one another, in a continuous extruder at a temperature T1 for a time S1, wherein T1 is not greater than a decomposition temperature Th1 at which the organic peroxide has a half-life of 1 hour, and S1 is shorter than a half-life Sh1 of the organic peroxide at T1, thereby forming a first blend;
(2) blending the first blend in the continuous extruder at a temperature T2 for a time S2, wherein T2 is at least as high as a decomposition temperature Th2 at which the organic peroxide has a half-life of 10 seconds, and S2 is at least as long as three times a half-life Sh2 of the organic peroxide at T2, thereby forming a second blend; and
(3) blending the second blend in the continuous extruder at a temperature T3 for a time S3, wherein T3 is not greater than a decomposition temperature Th3 at which the organic peroxide has a half-life of 10 hours, and S3 is at least as long as S2.

2. The process according to claim 1, wherein the olefin polymer prior to modification is produced by a production method comprising the step of polymerizing an olefin in the presence of a metallocene catalyst, and wherein the olefin polymer has a melt flow rate of 50 to 10,000 g/10 minutes and a molecular weight distribution of 2.5 or less.

3. The process according to claim 1, wherein the organic peroxide has a half-life of 1 minute at a decomposition temperature of 90 to 210° C.

4. The process according to claim 2, wherein the organic peroxide has a half-life of 1 minute at a decomposition temperature of 90 to 210° C.
